(19) United States
(12) Patent Application Publication
(10) Pub. No.: US 2016/0318044 A1
(43) Pub. Date: Nov. 3, 2016

(54) Showerhead Structure

(71) Applicant: Shih-Yu Chung, Lukang Township (TW)

(72) Inventor: Shih-Yu Chung, Lukang Township (TW)

(21) Appl. No.: 15/060,867

(22) Filed: Mar. 4, 2016

(30) Foreign Application Priority Data
Apr. 29, 2015 (TW) 104206572

(51) Int. Cl. B05B 1/18

(52) U.S. Cl. CPC B05B 1/185

(57) ABSTRACT

A showerhead structure contains: a water supply disc, a water guiding disc, a covering casing, and a decoration cover. The water supply disc includes a first face, a second face, and multiple through orifices. The water guiding disc includes multiple spray protrusion, each spray protrusion has a peripheral trench retained with a respective one of the multiple through orifices, and between the peripheral trench and said each spray protrusion is defined a retaining space. The covering casing is covered on the second face so as to clamp the water guiding disc between the covering casing and the water supply disc, and between the covering casing and the water guiding disc forms an accommodation room. The covering casing further includes a connecting knob for connecting with a water source, and the decoration cover includes a body having plural locking holes, wherein each locking hole retains in the retaining space.

### BACKGROUND OF THE INVENTION

1. Field of the Invention

The present invention relates to a showerhead structure which has aesthetics appearance and is machined easily.

2. Description of the Prior Art

Shower equipment contains a fixed showerhead and a manual showerhead, wherein the fixed showerhead is mounted on a wall and is in connection with a water pipe so that water flows into the fixed showerhead and then sprays out of spray nozzles of the fixed showerhead downwardly, thus taking a shower. This fixed showerhead is assembled easily and securely, but its size and aesthetics appearance cannot be improved greatly.

To overcome above-mentioned defects, a slim fixed showerhead is disclosed in FIGS. 10 and 11 and contains a water supply disc 10, a water guiding disc 20, and a covering casing 30, wherein the water supply disc 10 includes a first face 101, a second face 102 opposite to the first face 101, and a plurality of orifices 103 arranged on the water supply disc 10 and communicating with the first face 101 and the second face 102.

The water guiding disc 20 is flexible and contacts with the second face 102 of the water supply disc 10, and the water guiding disc 20 includes multiple spray protrusions 201 arranged on one surface thereof and extending out of the plurality of through orifices 103 of the water supply disc 10 respectively, wherein each spray protrusion 201 has a peripheral trench 202 defined around a peripheral side thereof, and a height of the peripheral trench 202 mates with a thickness of the water supply disc 10, such that the peripheral trench 202 retains with a respective one of the plurality of through orifices 103.

The covering casing 30 is covered on the second face 102 of the water supply disc 10 and includes a plurality of first fixing holes 301 corresponding to multiple second fixing holes 104 of the water supply disc 10 respectively, and a plurality of screws 302 insert through the plurality of first fixing holes 301 and the multiple second fixing orifices 104 so as to screw with multiple screw nuts 303, individually, thus connecting the covering casing 30 and the water supply disc 10 together. Between the covering casing 30 and the water guiding disc 20 defines an accommodation room 40, and the water guiding disc 20 is clamped between the covering casing 30 and the water supply disc 10, wherein the multiple spray protrusions 201 of the water guiding disc 20 are in communication with the accommodation room 40. The covering casing 30 includes a connecting knob 304 arranged on a central position thereof and configured to connect with a water source. In operation, water flows into the covering casing 30 from the connecting knob 304 and then sprays out of the multiple spray protrusions 201 of the water guiding disc 20 via the accommodation room 40 between the covering casing 30 and the water guiding disc 20, hence user takes a shower.

The plurality of screws 302 of the slim fixed showerhead expose outside the first face 101 of the water supply disc 10 to cause a poor appearance.

To solve above-described problem, another slim fixed showerhead is disclosed in FIGS. 12 and 13 and contains a water supply disc 50, a water guiding disc 60, and a covering casing 70, wherein the water supply disc 50 includes a first face 501, a second face 502 opposite to the first face 501, and a plurality of orifices 503 arranged on the water supply disc 50 and communicating with the first face 501 and the second face 502. The water supply disc 50 further includes multiple locking elements 504 welded adjacent to a peripheral side of the second face 502 thereof, wherein each locking element 504 has inner threads formed therein.

The water guiding disc 60 is flexible and contacts with the second face 502 of the water supply disc 50, and the water guiding disc 60 includes a plurality of spray protrusions 601 arranged on one surface thereof facing the water supply disc 50 and extending into a plurality of through orifices 503 of the water supply disc 50 respectively, wherein each spray protrusion 601 has a peripheral trench 602 defined around a peripheral side thereof, and a height of the peripheral trench 602 matches with a thickness of the water supply disc 50, such that the peripheral trench 602 retains with a respective one of the plurality of through orifices 503.

The covering casing 70 is covered on the second face 502 of the water supply disc 50 and includes multiple openings 701 corresponding to the multiple locking elements 504 of the water supply disc 50, individually. A plurality of screws 702 insert through the multiple openings 701 so as to screw with the plurality of locking elements 504 of the water supply disc 50 individually, thus locking the covering case 70 and the water supply disc 50 together. Between the covering casing 70 and the water guiding disc 60 defines an accommodation 80, and the water guiding disc 60 is clamped between the covering casing 70 and the water supply disc 50, wherein the plurality of spray protrusions 601 are in communication with the accommodation room 80. The covering casing 70 further includes a connecting knob 703 configured to connect with a water source. In operation, water flows into the accommodation room 80 between the covering casing 70 and the water guiding disc 60 from the connecting knob 703 and then sprays out of the multiple spray protrusions 601 of the water guiding disc 60, thus taking a shower.

However, the multiple locking elements 504 of the slim fixed showerhead are welded adjacent to the second face 502 of the waters supply disc 50 to cause difficult machining and poor stability. Moreover, a positioning error of said each locking element 504 occurs to have defective rate, and a welding defacement happens on the first face 501 of the water supply disc 50, so polishing the first face 501 of the water supply disc 50 to eliminate the welding defacement will increase machining time and production cost.

The present invention has arisen to mitigate and/or obviate the afore-described disadvantages.

### SUMMARY OF THE INVENTION

The primary objective of the present invention is to provide a showerhead structure which has outstanding quality and aesthetics appearance and is machined easily in a short time. Another objective of the present invention is to provide a showerhead structure which is manufactured at lower production cost and defective rate, thus increasing market competitiveness.

To obtain above objectives, a showerhead structure provided by a preferred embodiment of the present invention contains: a water supply disc, a water guiding disc, a covering casing, and a decoration cover.

The water supply disc includes a first face, a second face opposite to the first face, and a plurality of through orifices passing through the first face and the second face.

The water guiding disc is flexible and contacts with the second face of the water supply disc, and the water guiding disc includes multiple spray protrusions arranged on one surface thereof facing the water supply disc and extending out of the plurality of through orifices respectively, wherein each spray protrusion has a peripheral trench defined around a peripheral side thereof and retained with a respective one of the plurality of through orifices of the water supply disc, and between the peripheral trench and said each spray protrusion is defined a retaining space.

The covering casing is covered on the second face of the water supply disc in a locking manner so as to clamp the water guiding disc between the covering casing and the water supply disc, wherein between the covering casing and the water guiding disc forms an accommodation room communicating with the multiple spray protrusions, and the covering casing further includes a connecting knob configured to connect with a water source and communicating with the accommodation room.

The decoration cover includes a body corresponding to the water supply disc and contacting with the first face of the water supply disc, and the body has a plurality of locking holes arranged thereon and corresponding to the plurality of through orifices of the water supply disc, individually, wherein each locking hole retains in the retaining space between the peripheral trench and said each spray protrusion of the water guiding disc, such that the decoration cover is fixed on the first face of the water supply disc.

In another embodiment, a showerhead structure provided by a preferred embodiment of the present invention contains: a water supply disc, multiple spray protrusions, a covering casing, and a decoration cover.

The water supply disc includes a first face, a second face opposite to the first face, and a plurality of through orifices passing through the first face and the second face.

The multiple spray protrusions extend out of the plurality of through orifices respectively, wherein each spray protrusion has a peripheral trench defined around a peripheral side thereof and retained with a respective one of the plurality of through orifices of the water supply disc, and between the peripheral trench and said each spray protrusion is defined a retaining space.

The covering casing is covered on the second face of the water supply disc in a locking manner so as to clamp a water guiding disc between the covering casing and the water supply disc, wherein between the covering casing and the water guiding disc forms an accommodation room communicating with the multiple spray protrusions, and the covering casing further includes a connecting knob configured to connect with a water source and communicating with the accommodation room.

The decoration cover including a body corresponding to the water supply disc and contacting with the first face of the water supply disc, and the body having a plurality of locking holes arranged thereon and corresponding to the plurality of through orifices of the water supply disc, individually, wherein each locking hole retains in the retaining space between the peripheral trench and said each spray protrusion of the water guiding disc, such that the decoration cover is fixed on the first face of the water supply disc.

### BRIEF DESCRIPTION OF THE DRAWINGS

FIG. 1 is a perspective view showing the assembly of a showerhead structure in accordance with a preferred embodiment of the present invention.

FIG. 2 is a perspective view showing the exploded components of the showerhead structure in accordance with the preferred embodiment of the present invention.

FIG. 3 is another perspective view showing the assembly of the showerhead structure in accordance with the preferred embodiment of the present invention.

FIG. 4 is a cross sectional view showing the assembly of a part of the showerhead structure in accordance with the preferred embodiment of the present invention.

FIG. 5 is a cross sectional view showing the assembly of the showerhead structure in accordance with the preferred embodiment of the present invention.

FIG. 6 is an amplified cross-sectional view of a portion A1 of FIG. 5.

FIG. 7 is an amplified cross-sectional view of a portion A2 of FIG. 5.

FIG. 8 is a cross sectional view showing the assembly of a showerhead structure in accordance with another preferred embodiment of the present invention.

FIG. 9 is an amplified cross-sectional view of a portion A3 of FIG. 8.

FIG. 10 is a cross sectional view showing the assembly of a conventional showerhead structure.

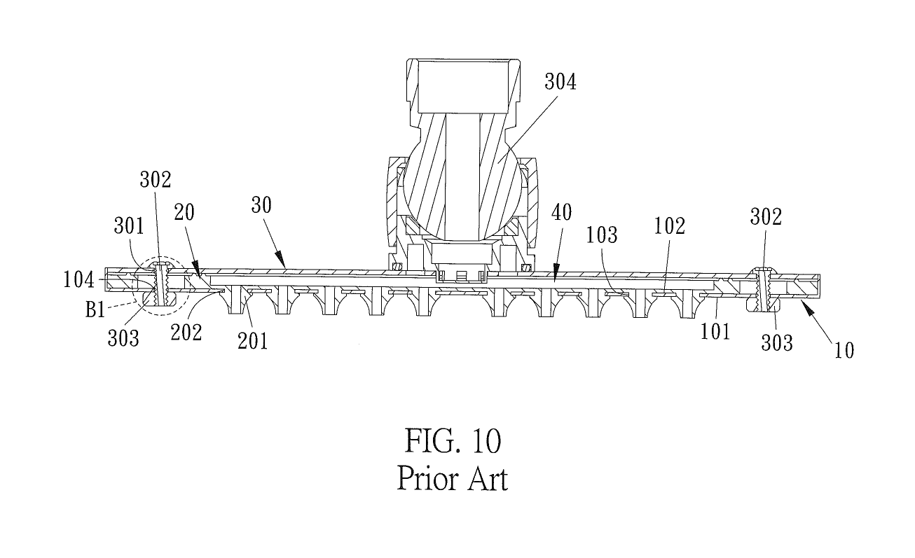

FIG. 11 is an amplified cross-sectional view of a portion B1 of FIG. 10.

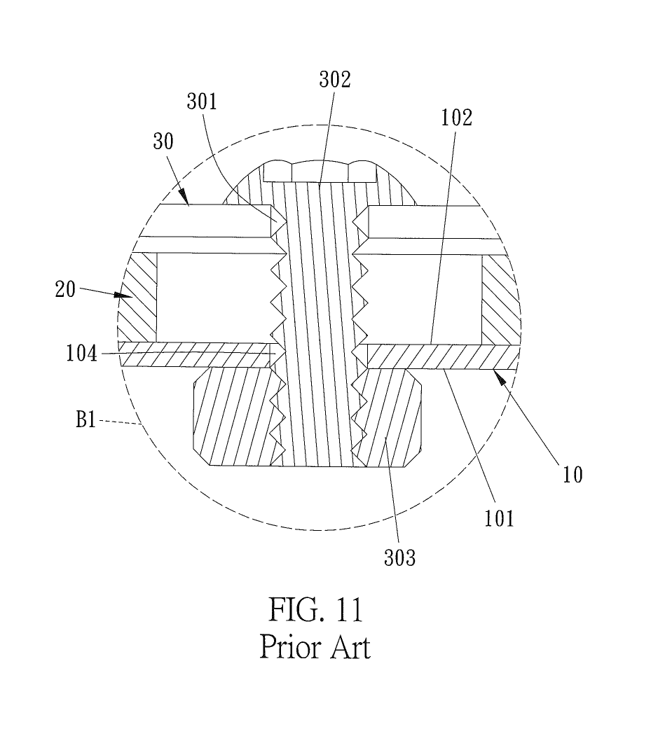

FIG. 12 is a cross sectional view showing the assembly of another conventional showerhead structure.

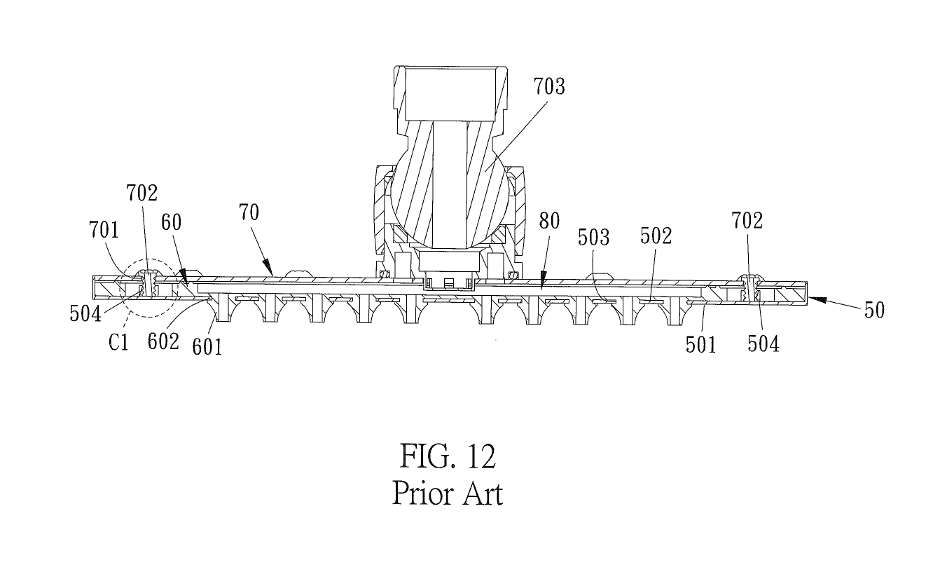

FIG. 13 is an amplified cross-sectional view of a portion C1 of FIG. 12.

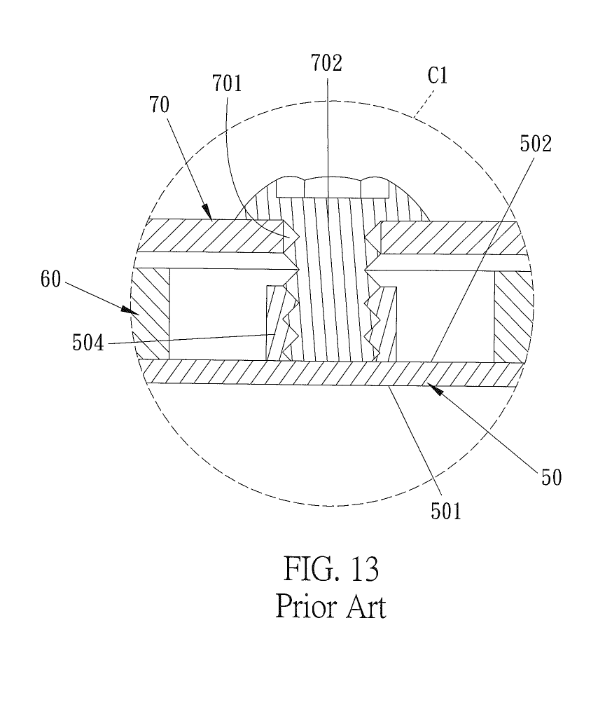

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

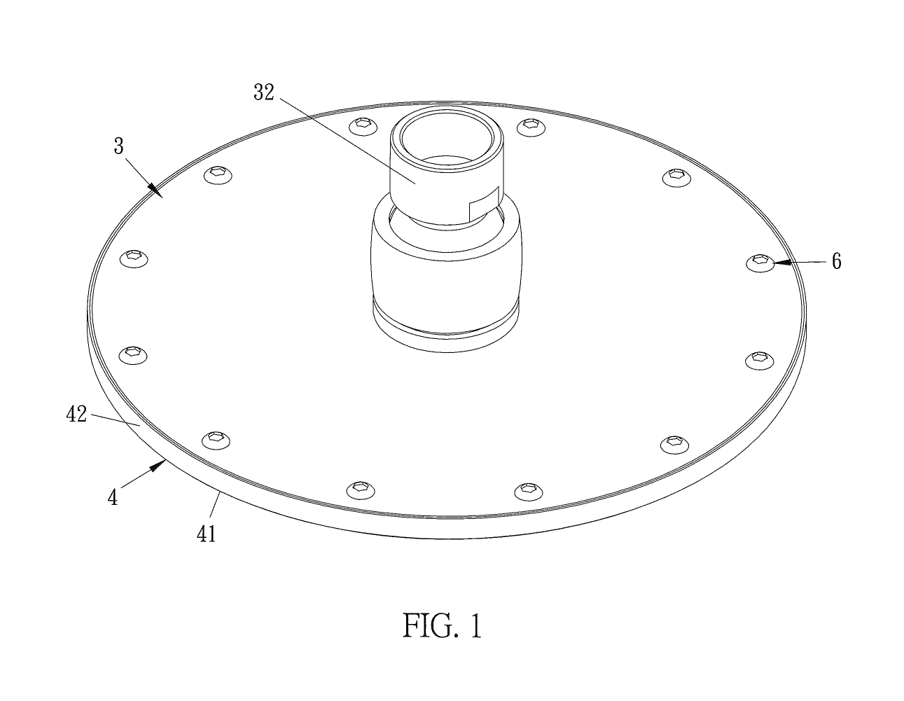

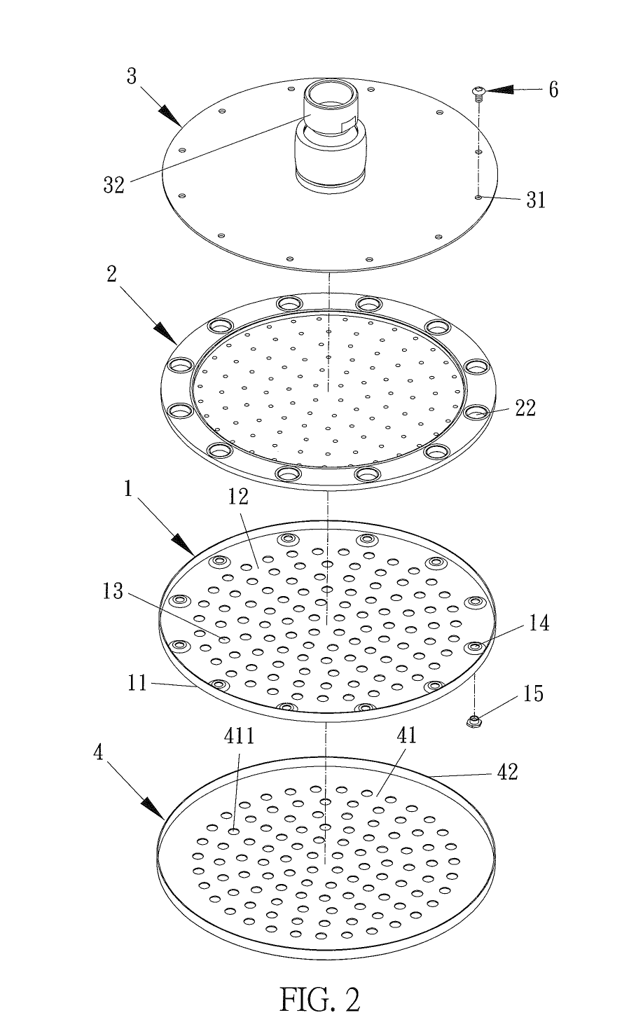

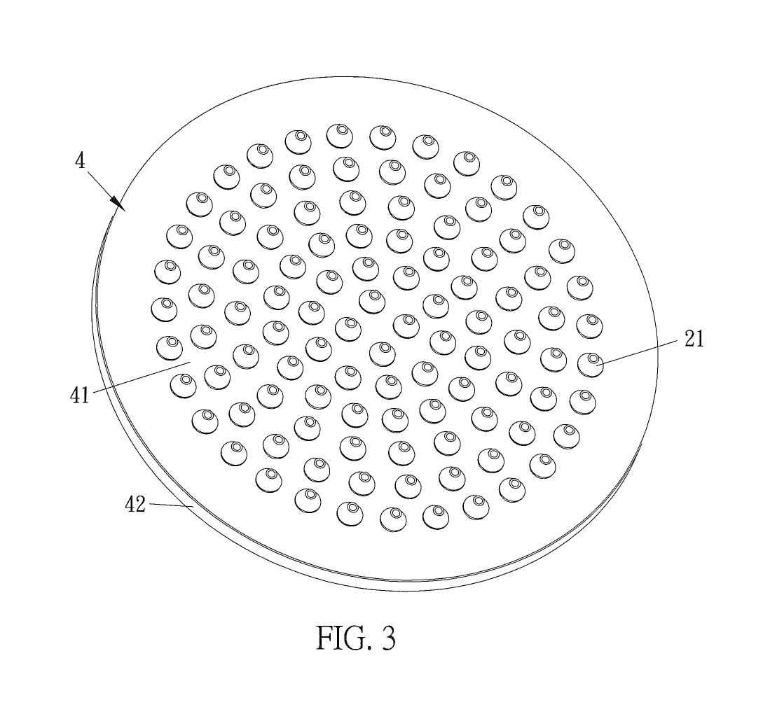

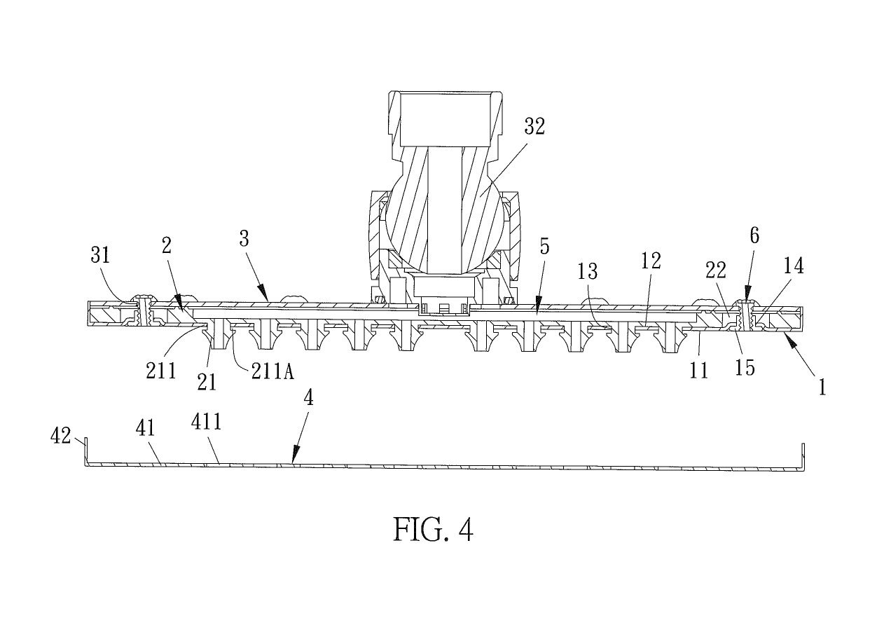

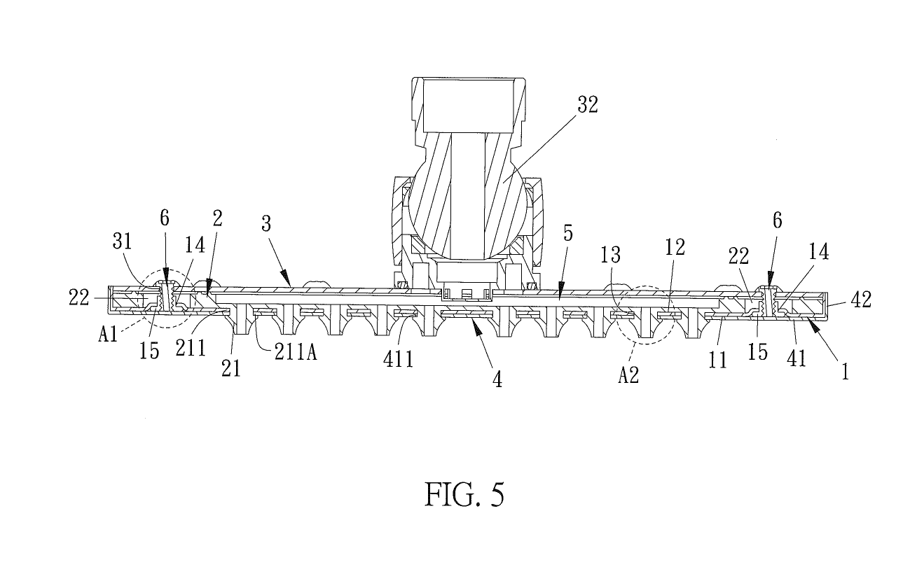

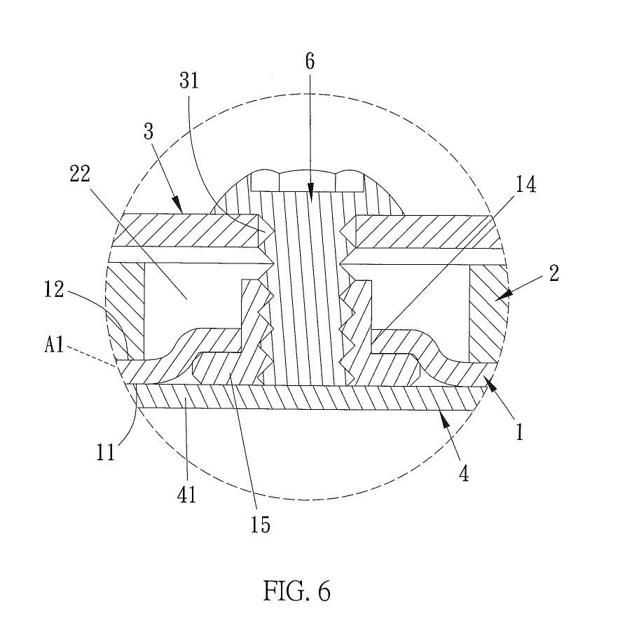

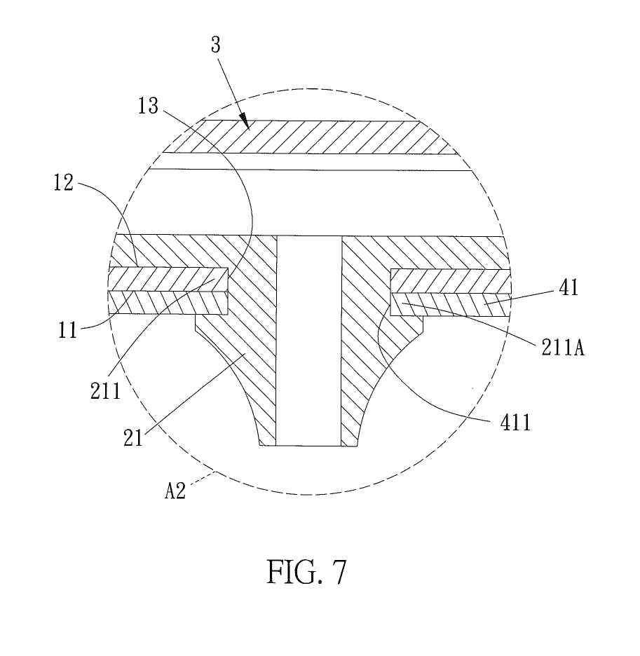

With reference to FIGS. 1-7, a showerhead structure according to a preferred embodiment of the present invention comprises: a water supply disc 1, a water guiding disc 2, a covering casing 3, and a decoration cover 4.

The water supply disc 1 includes a first face 11, a second face 12 opposite to the first face 11, a plurality of through orifices 13 passing through the first face 11 and the second face 12, multiple notches 14 stamped around a peripheral side of the first face 11 of the water supply disc 1, and a plurality of locking elements 15 retained in the multiple notches 14, respectively, wherein each locking element 15 has inner threads formed therein.

The water guiding disc 2 is flexible and contacts with the second face 12 of the water supply disc 1, and the water guiding disc 2 includes multiple spray protrusions 21 arranged on one surface thereof facing the water supply disc 1 and extending out of the plurality of through orifices 13 respectively, wherein each spray protrusion 21 has a peripheral trench 211 defined around a peripheral side thereof and retained with a respective one of the plurality of through orifices 13 of the water supply disc 1, and between the peripheral trench 211 and said each spray protrusion 21 is defined a retaining space 211A. The water guiding disc 2 also includes a plurality of apertures 22 arranged proximate to a peripheral side thereof and corresponding to the multiple notches 14, respectively.

The covering casing 3 is covered on the second face 12 of the water supply disc 1 and includes multiple openings 31 arranged adjacent to a peripheral side of the covering casing 3 and corresponding to the multiple notches 14 of the water supply disc 1, individually. A plurality of screws 6 insert through the multiple openings 31 of the covering casing 3 and the plurality of apertures 22 of the water guiding disc 2 so as to screw with the plurality of locking elements 15 which are retained in the multiple notches 14 of the water supply disc 1, respectively. The covering casing 3 is in connection with the water supply disc 1, and the water guiding disc 2 is clamped between the covering casing 3 and the water supply disc 1 so that between the covering casing 3 and the water guiding disc 2 forms an accommodation room 5 communicating with the multiple spray protrusions 21. Furthermore, the covering casing 3 further includes a connecting knob 32 disposed on a central position thereof, configured to connect with a water source and communicating with the accommodation room 5.

The decoration cover 4 includes a body 41 corresponding to the water supply disc 1 and includes a coupling rib 42 extending upwardly from a peripheral side of the body 41. The body 41 contacts with the first face 11 of the water supply disc 1 and has a plurality of locking holes 411 arranged thereon and corresponding to the plurality of through orifices 13, individually, wherein each locking hole 411 retains in the retaining space 211A between the peripheral trench 211 and said each spray protrusion 21 of the water guiding disc 2, such that the decoration cover 4 is engaged by said each spray protrusion 21 of the water guiding disc 2 and contacts with the first face 11 of the water supply disc 1, and coupling rib 42 covers a peripheral side of the water supply disc 1 and the peripheral side of the covering casing 3.

In assembly, the water guiding disc 2 contacts with the second face 12 of the water supply disc 1 so that the multiple spray protrusions 21 of the water guiding disc 2 extend out of the plurality of through orifices 13 of the water supply disc 1 individually, and the peripheral trench 211 of said each spray protrusion 21 retains with the respective one of the plurality of through orifices 13 of the water supply disc 1, wherein between the peripheral trench 211 and said each spray protrusion 21 is defined a retaining space 211A, and the covering casing 3 is covered on the second face 12 of the water supply disc 1, thereafter the plurality of screws 6 insert through the multiple openings 31 of the covering casing 3 and the plurality of apertures 22 of the water guiding disc 2 respectively so as to screw with the plurality of locking elements 15 which are retained in the multiple notches 14 of the water supply disc 1, individually. The body 41 of the decoration cover 4 contacts with the first face 11 of the water supply disc 1, and sad each locking hole 411 of the body 41 retains in the retaining space 211A between the peripheral trench 211 and said each spray protrusion 21 of the water guiding disc 2, hence said each spray protrusion 21 extends out of the decoration cover 4, and the shower structure is assembled completely.

In operation, the connecting knob 32 connects with a water pipe so that water flows into the accommodation room 5 between the covering casing 3 and the water guiding disc 2, and sprays out of said each spray protrusion 21 of the water guiding disc 2, hence user takes a shower.

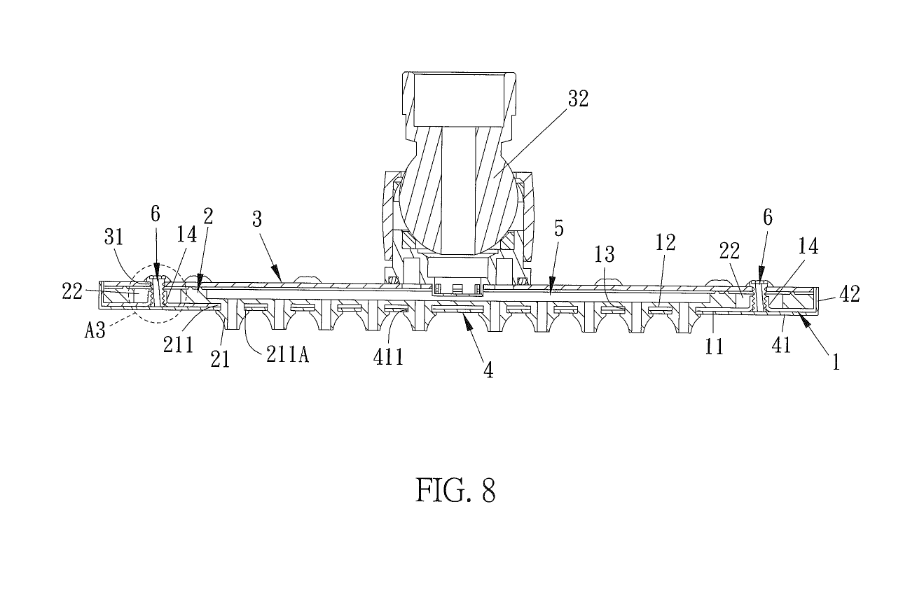

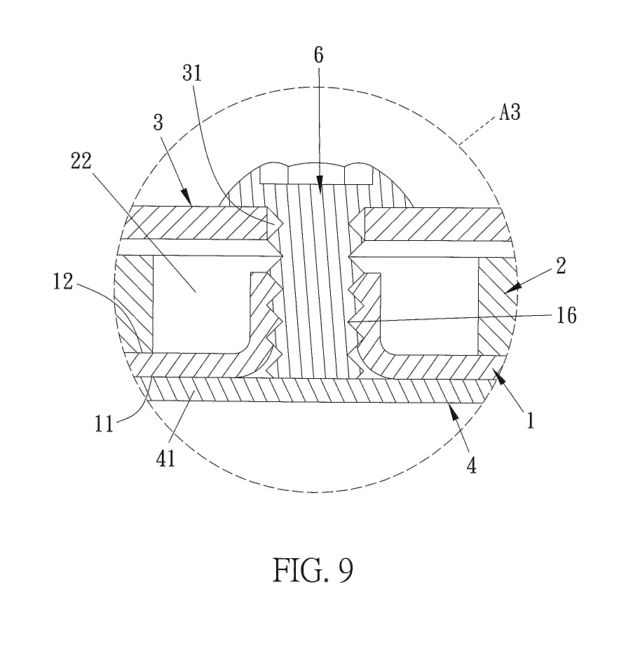

It is to be noted that each locking element 15 is retained in a respective one of the multiple notches 14 and has inner threads arranged therein so as to screw with a respective one of the plurality of screws 6. In addition, as shown in FIGS. 8 and 9, the water supply disc 1 includes a plurality of threaded holes 16 stamped proximate to the peripheral side of the first face 11 of the water supply disc 1 and extending toward the second face 12 of the water supply disc 1, such that the plurality of threaded holes 16 screw with the plurality of screws 6 respectively so as to connect the covering casing 3 with the water supply disc 1, and the water guiding disc 2 is clamped between the covering casing 3 and the water supply disc 1.

Thereby, the showerhead structure of the present invention has advantages as follows:

The showerhead structure has outstanding quality and aesthetics appearance and is machined easily in a short time. Preferably, the showerhead structure is manufactured at lower production cost and defective rate, thus increasing market competitiveness.

While we have shown and described various embodiments in accordance with the present invention, it is clear to those skilled in the art that further embodiments may be made without departing from the scope of the present invention.

What is claimed is:

1. A showerhead structure comprising:
a water supply disc including a first face, a second face opposite to the first face, and a plurality of through orifices passing through the first face and the second face;
a water guiding disc being flexible and contacting with the second face of the water supply disc, and the water guiding disc including multiple spray protrusions arranged on one surface thereof facing the water supply disc and extending out of the plurality of through orifices respectively, wherein each spray protrusion has a peripheral trench defined around a peripheral side thereof and retained with a respective one of the plurality of through orifices of the water supply disc, and between the peripheral trench and said each spray protrusion is defined a retaining space;
a covering casing covered on the second face of the water supply disc in a locking manner so as to clamp the water guiding disc between the covering casing and the water supply disc, wherein between the covering casing and the water guiding disc forms an accommodation room communicating with the multiple spray protrusions, and the covering casing further includes a connecting knob configured to connect with a water source and communicating with the accommodation room;
a decoration cover including a body corresponding to the water supply disc and contacting with the first face of the water supply disc, and the body having a plurality of locking holes arranged thereon and corresponding to the plurality of through orifices of the water supply disc, individually, wherein each locking hole retains in the retaining space between the peripheral trench and said each spray protrusion of the water guiding disc, such that the decoration cover is fixed on the first face of the water supply disc.

2. The showerhead structure as claimed in claim 1, wherein the water supply disc includes multiple notches stamped around a peripheral side of the first face of the water supply disc and extending toward the second face of the water supply disc, and the water supply disc also includes a plurality of locking elements retained in the multiple notches, respectively, wherein each locking element has inner threads formed therein, and the water guiding disc also includes a plurality of apertures corresponding to the multiple notches of the water supply disc respectively, the covering casing includes multiple openings arranged adjacent to a peripheral side thereof and corresponding to the multiple notches of the water supply disc individually, wherein a plurality of screws insert through the multiple openings of the covering casing and the plurality of apertures of the water guiding disc so as to screw with the plurality of locking elements which are retained in the multiple notches of the water supply disc, respectively.

3. The showerhead structure as claimed in claim 1, wherein the water supply disc includes a plurality of threaded holes stamped around a peripheral side of the first face of the water supply disc and extending toward the second face of the water supply disc, and the water guiding disc also includes a plurality of apertures corresponding to the multiple notches of the water supply disc respectively, the covering casing includes multiple openings arranged adjacent to a peripheral side thereof and corresponding to the multiple notches of the water supply disc individually, wherein a plurality of screws insert through the multiple openings of the covering casing and the plurality of apertures of the water guiding disc so as to screw with the plurality of threaded holes of the water supply disc, individually.

4. The showerhead structure as claimed in claim 1, wherein the decoration cover also includes a coupling rib extending upwardly from a peripheral side of the body so as to cover a peripheral side of the water supply disc and the peripheral side of the covering casing.

5. A showerhead structure comprising:
a water supply disc including a first face, a second face opposite to the first face, and a plurality of through orifices passing through the first face and the second face;
multiple spray protrusions extending out of the plurality of through orifices respectively, wherein each spray protrusion has a peripheral trench defined around a peripheral side thereof and retained with a respective one of the plurality of through orifices of the water supply disc, and between the peripheral trench and said each spray protrusion is defined a retaining space;
a covering casing covered on the second face of the water supply disc in a locking manner so as to clamp a water guiding disc between the covering casing and the water supply disc, wherein between the covering casing and the water guiding disc forms an accommodation room communicating with the multiple spray protrusions, and the covering casing further includes a connecting knob configured to connect with a water source and communicating with the accommodation room;
a decoration cover including a body corresponding to the water supply disc and contacting with the first face of the water supply disc, and the body having a plurality of locking holes arranged thereon and corresponding to the plurality of through orifices of the water supply disc, individually, wherein each locking hole retains in the retaining space between the peripheral trench and said each spray protrusion of the water guiding disc, such that the decoration cover is fixed on the first face of the water supply disc.

6. The showerhead structure as claimed in claim 5, wherein the water supply disc includes multiple notches stamped around a peripheral side of the first face of the water supply disc and extending toward the second face of the water supply disc, and the water supply disc also includes a plurality of locking elements retained in the multiple notches, respectively, wherein each locking element has inner threads formed therein, and the covering casing includes multiple openings arranged adjacent to a peripheral side thereof and corresponding to the multiple notches of the water supply disc individually, wherein a plurality of screws insert through the multiple openings of the covering casing so as to screw with the plurality of locking elements which are retained in the multiple notches of the water supply disc, respectively.

7. The showerhead structure as claimed in claim 5, wherein the water supply disc includes a plurality of threaded holes stamped around a peripheral side of the first face of the water supply disc and extending toward the second face of the water supply disc, and the covering casing includes multiple openings arranged adjacent to a peripheral side thereof and corresponding to the multiple notches of the water supply disc individually, wherein a plurality of screws insert through the multiple openings of the covering casing so as to screw with the plurality of threaded holes of the water supply disc, individually.

8. The showerhead structure as claimed in claim 5, wherein the decoration cover also includes a coupling rib extending upwardly from a peripheral side of the body so as to cover a peripheral side of the water supply disc and the peripheral side of the covering casing.
